(19) United States
(12) Patent Application Publication
(10) Pub. No.: US 2016/0176068 A1
(43) Pub. Date: Jun. 23, 2016

(54) WORKPIECE DISTRESSING SYSTEM

(71) Applicant: ARMSTRONG WORLD INDUSTRIES, INC., Lancaster, PA (US)

(72) Inventors: MATTHEW S. MYERS, Lititz, PA (US); JAMES P. VALENTI, Lititz, PA (US)

(21) Appl. No.: 14/970,662

(22) Filed: Dec. 16, 2015

Related U.S. Application Data
(60) Provisional application No. 62/095,043, filed on Dec. 21, 2014.

(51) Int. Cl. B27M 1/00; B44C 1/00

(52) U.S. Cl. CPC B27M 1/003; B44C 1/00

(57) ABSTRACT

A system and related methods are disclosed for distressing a workpiece, which may be a building surfacing material. The system may include a material support defining a material support plane for supporting the workpiece and a distressing apparatus mounted adjacent the material support. The distressing apparatus includes a cutting blade and is configured to translate the blade back-and-forth along an impact axis between: (1) an extended or projected state in which the blade edge is a first distance from the material support plane; and (2) a retracted state in which the blade edge is a second distance from the material support plane greater than the first distance. A drive subsystem generates relative movement between the workpiece and distressing apparatus. A controller repetitively reciprocates the blade back-and forth to repetitively impact the workpiece, thereby forming a chatter mark on the workpiece surface comprised of substantially parallel seriatim angled grooves or cuts.

### FIELD

The present invention relates to tooling systems, and more particularly to a system for distressing a workpiece.

### BACKGROUND

Sheets or planks of building surfacing materials used to form flooring, wall, or ceiling systems are sometimes provided with a distressed surface. This creates a rustic or antiqued appearance which is sometimes sought for certain visual aesthetics. An improved automated tooling system to produce distressed surfacing materials is desired.

### SUMMARY

A system is provided which is configured to produce a distressed surface effect on a workpiece suitable for use as a building surfacing material. In some embodiments, the workpiece may be a generally planar or flat sheet or plank of material that can be used to construct floors, walls, and/or ceilings. The workpiece may be formed of natural or man-made products. In one embodiment, the workpiece may be formed of solid wood or a composite wood structure.

In one embodiment, a system for distressing a major surface of a plank includes: a material support defining a material support plane for supporting the plank; a distressing apparatus mounted adjacent the material support, the distressing apparatus comprising a blade terminating in a blade edge, the distressing apparatus configured to translate the blade back-and-forth along an impact axis between: (1) an extended state in which the blade edge is a first distance from the material support plane; and (2) a retracted state in which the blade edge is a second distance from the material support plane, the second distance being greater than the first distance; a drive subsystem configured to generate relative movement between the plank and the distressing apparatus so that the plank translates relative to the distressing apparatus so as to define a material feed direction; the distressing apparatus mounted adjacent the material support so that the impact axis is obliquely oriented relative to the material support plane and intersects the material support plane at an intersection point so as to form an acute angle with a portion of the material support plane that is downstream of the intersection point and an obtuse angle with a portion of the material support plane that is upstream of the intersection point, wherein downstream and upstream are defined with respect to the material feed direction; and a controller operably coupled to the distressing apparatus and to the drive subsystem, the controller configured to repetitively fire the blade back-and forth between the extended state and the retracted state for a period of time so that the blade edge repetitively impacts the major surface of the plank when in the extended state as the plank is translated in the material feed direction by the drive subsystem, thereby forming a chatter mark in the major surface of the plank. In some embodiments, the system further includes the distressing apparatus configured so that the blade edge is translatable relative to the material support in an across-feed direction, an across-feed direction actuator operably coupled to the distressing apparatus to translate the blade edge in the across-feed direction, and the controller operably coupled to the across-feed direction actuator and configured to position the blade edge in a selected one of a plurality of across-feed direction positions.

In one embodiment, a method of distressing a major surface of a plank is provided. The methods includes: a) supporting the plank on a material support; b) creating relative translational movement between the plank and a distressing apparatus mounted adjacent the material support using a drive subsystem, the distressing apparatus comprising a blade terminating in a blade edge, the plank translating relative to the distressing apparatus so as to define a material feed direction; and c) repetitively firing the blade back-and-forth along an impact axis between (1) an extended state in which the blade edge is driven into the major surface of the plank, and (2) a retracted state in which the blade edge is a spaced a distance from the major surface of the plank, thereby creating a chatter mark in the major surface of the plank; and wherein step c) is performed while continuing said relative translational movement of step b).

### BRIEF DESCRIPTION OF THE DRAWINGS

The features of the exemplary embodiments of the present invention will be described with reference to the appended drawings, where like elements are labeled similarly.

FIG. 1 is side view of a distressing apparatus.

FIG. 2 is a perspective view of a portion thereof showing the articulating cutting tool units.

FIG. 3 is a perspective view thereof showing a single cutting tool unit with overhead gantry-style crane or support assembly.

FIG. 4 is a perspective view thereof showing the single cutting tool unit without the top mounting plate.

FIG. 5 is a side view of a cutting tool unit showing some of the ranges of motions of the articulating unit.

FIG. 6 is a side view of two cutting tool units, a material support, and workpiece positioned on the material support during the distressing operation. The cutting blade are shown not engaged with the workpiece.

FIG. 6A is a detailed view from FIG. 6.

FIG. 7 is a side view similar to FIG. 6 showing one of the cutting unit blades engages with and distressing the workpiece.

FIG. 7A is a detailed view from FIG. 7.

FIG. 8 is a side view showing the tilting action of a cutting tool unit.

FIG. 9 is a front view showing the lateral across-feed direction motion of the cutting tool unit.

FIG. 10 is a top plan view of three cutting tool units each axially aligned along the material feed direction in the same lateral across-feed position.

FIG. 11 is a top plan view of three cutting tool units each in a different lateral across-feed position so that none of the units is axially aligned along the material feed direction with the other units.

FIG. 12 is a side view showing the height adjustment action of a cutting tool unit showing the cutting blade in a first elevated position.

FIG. 13 is a side view showing the height adjustment action of a cutting tool unit showing the cutting blade in a second elevated position.

FIG. 14 is a top plan view of a cutting tool unit showing the unit and cutting blade in a first rotational position axially aligned and parallel with respect to the material feed direction.

FIG. 15 is a top plan view of a cutting tool unit showing the unit and cutting blade in a second obliquely angled rotational position with respect to the material feed direction.

FIG. 16 is a top plan view of a cutting tool unit showing the unit and cutting blade in a third obliquely angled rotational position with respect to the material feed direction.

FIG. 17 is a cross-sectional view of a cutting tool unit having a pneumatic piston actuated cutting blade assembly in a first projected position.

FIG. 18 is a cross-sectional view thereof in a second retracted position.

FIG. 19 is a cross-sectional side view of the workpiece and an exemplary distress groove or cut formed therein by a cutting tool unit.

FIG. 20 is a top plan view of the workpiece showing a chatter mark formed by the cutting tool unit(s) comprised of a seriatim of grooves or cuts which are aligned perpendicular to the material feed direction.

FIG. 21 is a top plan view of the workpiece showing a chatter mark formed by the cutting tool unit(s) comprised of a seriatim of grooves or cuts which are obliquely aligned to the material feed direction.

All drawings are schematic and not necessarily to scale. Parts given a reference numerical designation in one figure may be considered to be the same parts where they appear in other figures without a numerical designation for brevity unless specifically labeled with a different part number and described herein.

### DETAILED DESCRIPTION

The features and benefits of the invention are illustrated and described herein by reference to exemplary embodiments. This description of exemplary embodiments is intended to be read in connection with the accompanying drawings, which are to be considered part of the entire written description. Accordingly, the disclosure expressly should not be limited to such exemplary embodiments illustrating some possible non-limiting combination of features that may exist alone or in other combinations of features.

In the description of embodiments disclosed herein, any reference to direction or orientation is merely intended for convenience of description and is not intended in any way to limit the scope of the present invention. Relative terms such as “lower,” “upper,” “horizontal,” “vertical,”, “above,” “below,” “up,” “down,” “top” and “bottom” as well as derivative thereof (e.g., “horizontally,” “downwardly,” “upwardly,” etc.) should be construed to refer to the orientation as then described or as shown in the drawing under discussion. These relative terms are for convenience of description only and do not require that the apparatus be constructed or operated in a particular orientation. Terms such as “attached,” “affixed,” “connected,” “coupled,” “interconnected,” and similar refer to a relationship wherein structures are secured or attached to one another either directly or indirectly through intervening structures, as well as both movable or rigid attachments or relationships, unless expressly described otherwise.

A system for distressing a surfacing material such as a plank or sheet of generally planar material will now be described. For convenience only, without limitation, the surfacing material described may be referred to as a plank having an axial length longer than a transverse cross width. Other shapes of surfacing materials including square, polygonal, and non-polygonal materials may be used. The surfacing material on which tooling will be performed to produce a distressed surface is also referred to herein as a workpiece.

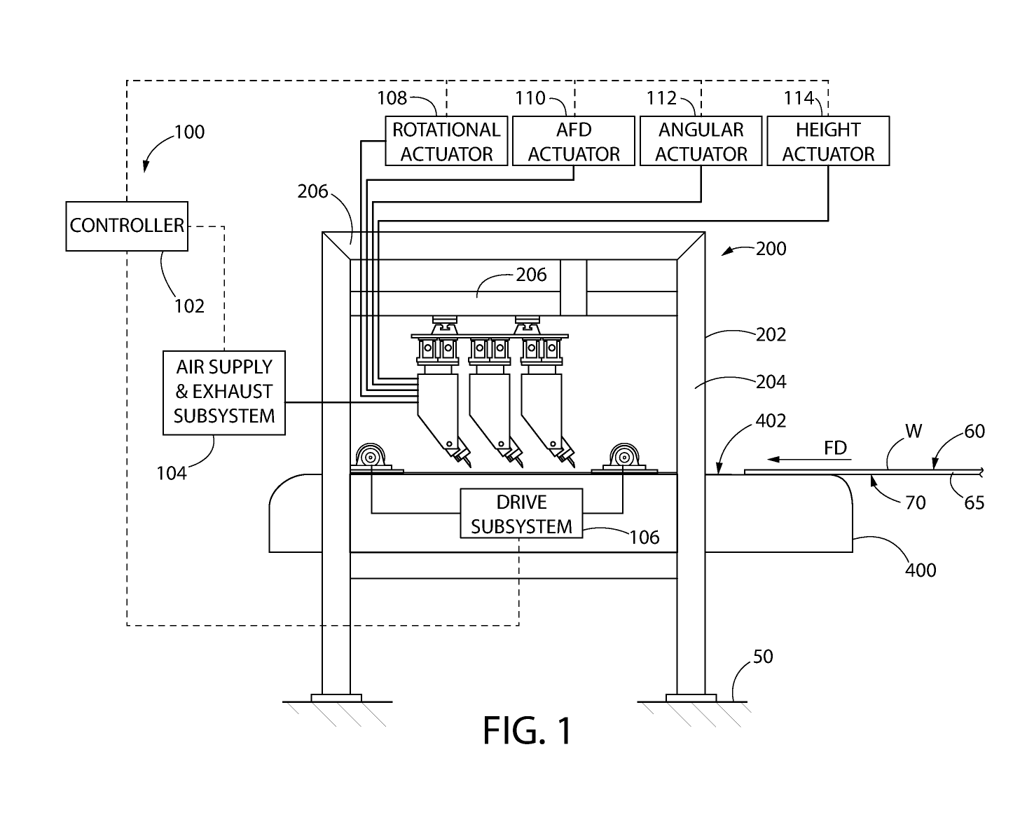

FIG. 1 shows a system for distressing the workpiece W. In one implementation, the system includes a fixed support assembly 200 which is rigidly mounted on a support base 50 and a distressing apparatus 300 supported by assembly 200. Base 50 may be a portion of a building superstructure such as a generally horizontal concrete floor or steel structural member(s) in some embodiments. Support assembly 200 may include a plurality of horizontally spaced apart vertical columns 204 affixed to base 50 and one or more generally horizontal support members 206 affixed transversely to and supported by the columns.

A material support 400 includes a top surface 402 which defines a material support plane for supporting the workpiece W. Material support 400 may be straddled by vertical support columns 204 on either lateral side such that the material support plane is positioned at least partially inside the fixed support assembly 200. A power drive subsystem 106 generates relative movement between the workpiece W and the distressing apparatus 300 so that the workpiece translates relative to the distressing apparatus so as to define a material feed direction (“FD”). In one configuration, top surface 402 of material support 400 may be movable along a linear path in the FD for translating the workpiece with respect to the distressing apparatus 300. An across feed direction (“AFD”) is defined as being transverse and perpendicular to the FD. The FD defines a longitudinal direction and the AFD defines a lateral direction.

In one embodiment, the material support 400 may be a motorized belt conveyor having a circulating continuous loop belt that defines a moving top surface 402 which automatically conveys the workpiece W along the linear FD path beneath the distressing apparatus 300. In other configurations contemplated, one or more topside-mounted drive rollers 404 may be included which apply downward pressure against and engage the workpiece W to translate the workpiece relative to the distressing apparatus 300. The material support 400 in such an embodiment with drive roller may include a plurality of longitudinally spaced idler rollers which support the bottom of workpiece W during movement through the distressing apparatus 300. In one configuration, drive rollers 404 may be provided proximate to either end of the distressing apparatus 300 as show in in FIG. 1 to stabilize the workpiece and positively move it through the distressing station. The drive rollers 404 further ensure that the workpiece W does not vibrate excessively during the distressing operation which might bind or otherwise adversely affect proper formation of the desired distress marks.

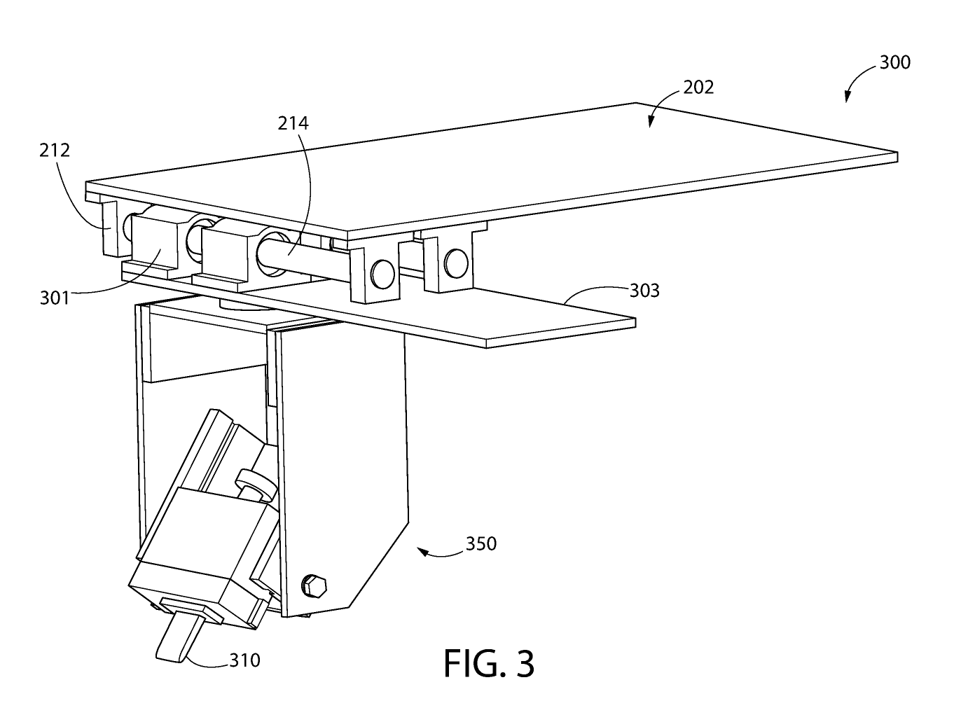

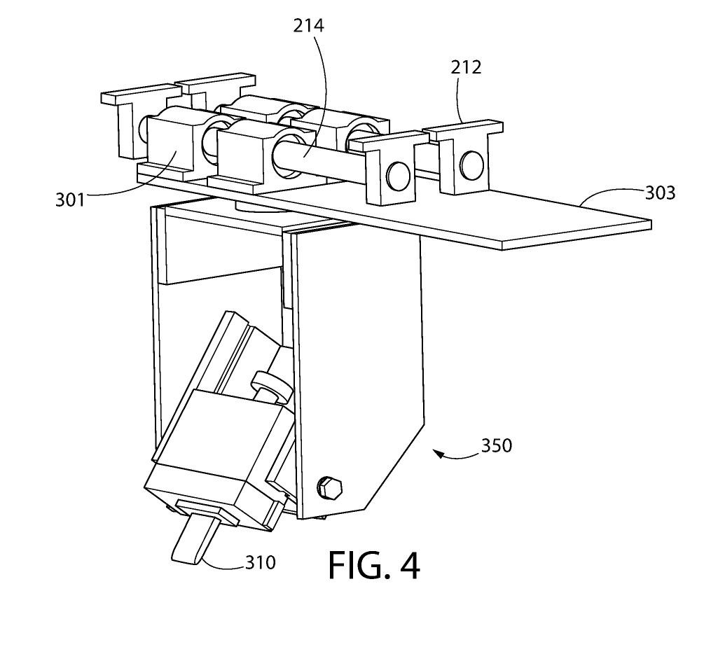

Referring to FIGS. 1-4, distressing apparatus 300 is configured and operable to form one or more distress marks into a surface of the workpiece W at various locations. The workpiece W may be a generally flat or planar sheet of material including a top major surface 60, opposing bottom major surface 70, and four peripheral sides 65 extending therebetween for a rectilinear workpiece. Other shapes of workpieces may have more or less peripheral sides. Bottom surface 70 of workpiece W rests on and contacts top surface 402 of material support 400.

Distressing apparatus 300 may be supported by support assembly 200 in a suspended manner from the horizontal support members 206. Distressing apparatus 300 is mounted adjacent to the material support 400, and in one embodiment may be disposed directly above and spaced vertically apart from the material support 400 (see, e.g. FIG. 1). An overhead gantry-style crane or support assembly 202 may be provided in one implementation which is rigidly attached to horizontal support members 206 for translating the distressing apparatus in the lateral or AFD (across-feed direction). This advantageously allows the distress marks to be readily located and changed in lateral position with respect to the workpiece W.

The distressing system may include one or more distressing apparatuses 300. Each distressing apparatus 300 includes one or more cutting tool units 350 each comprising an assembly of a carriage apparatus 302 supported in a suspended manner from above by the fixed support assembly 200, a tool support apparatus 304 mounted to the carriage apparatus, a tool carrier apparatus 306 mounted to the tool support apparatus, and a reciprocating tool apparatus 308 mounted to the tool carrier apparatus. The reciprocating tool apparatus 308 comprises a cutting head including at least one sharpened cutting blade 310 configured and arranged for cutting distress marks into the workpiece W. The distress marks or cuts may be a series of chatter marks as further described herein.

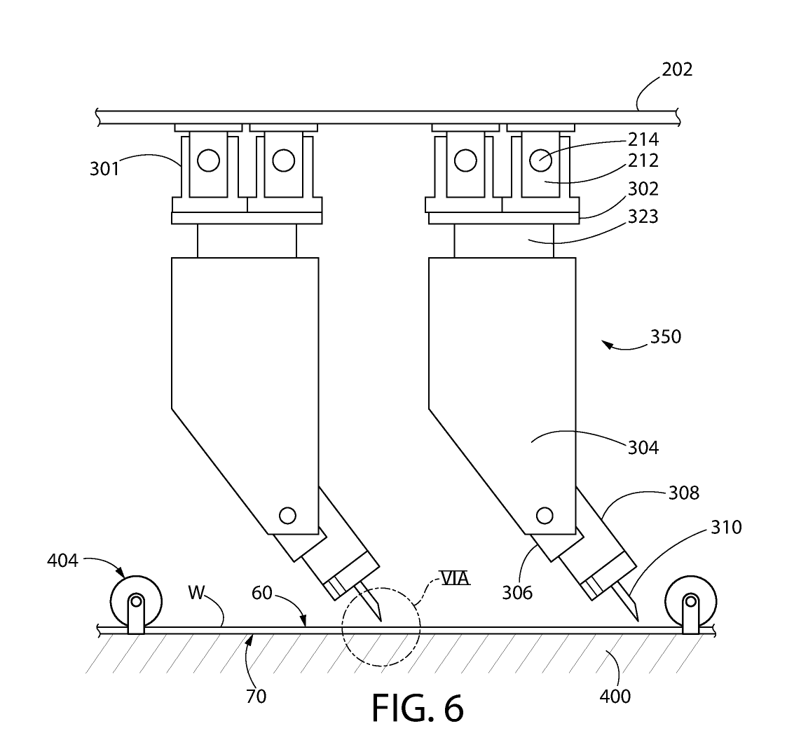

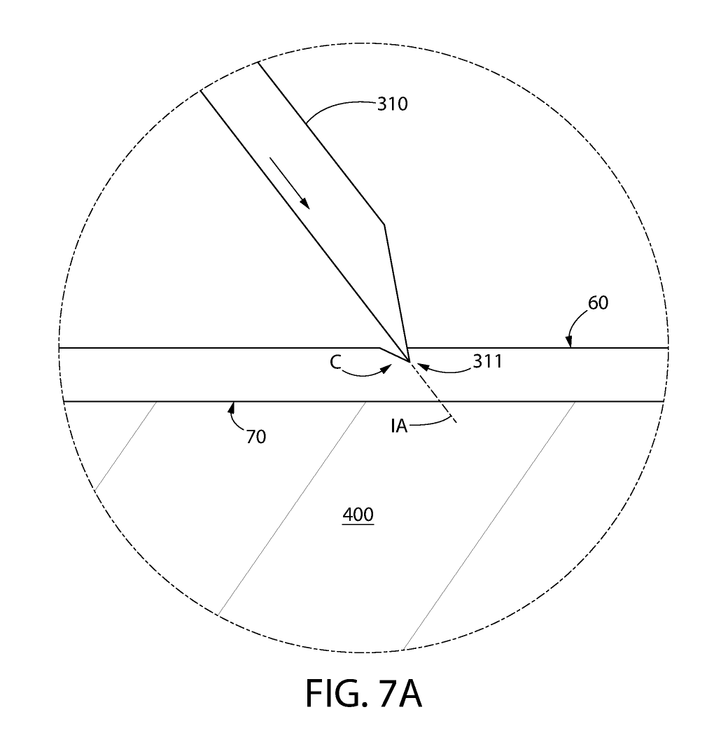

In one configuration, the blade 310 may be shaped similar to a chisel having a flat rear surface 312 facing the downstream feed direction FD and an obliquely angled flat front cutting surface 313 facing the upstream feed direction (see, e.g. FIG. 6A). The rear and front surfaces intersect at an apex which defines a sharply pointed tip 311 to engage the workpiece W. In some embodiments, the blade 310 has a larger transverse width measured perpendicular to the feed direction FD than thickness measured parallel to the feed direction FD (compare FIGS. 6A and 9). The tip 311 forms an elongated linear cutting edge for creating a cut having a width commensurate with the width of the blade (see FIG. 9). During the cutting/distressing operation, blade 310 remains fixed in position relative to the material support 400 and fixed support assembly 200 while the workpiece W is translated beneath the blade and cut.

Carriage apparatus 302 includes a support plate 303 which is attached to the laterally movable gantry support assembly 202. Plate 303 may be generally flat and horizontal in one embodiment. Gantry support 202 in one configuration includes a horizontal flat mounting plate 210, a pair of spaced apart rod supports 212 attached to the plate 210, and a support rod 214 mounted between the rod supports. In some embodiments as shown, two sets of foregoing assemblies may be provided to ensure flat plumb positioning of the support plates 303 with respect to the material support 400. The spacing of the rod supports 212 defines the maximum lateral travel or movement possible of the cutting tool unit assemblies. In one embodiment, a rod support 212 is mounted proximate to each lateral side of the mounting plate 210 to maximize the range of motion of the cutting tool units. In one embodiment, the support plate 303 of carriage apparatus 302 may be arranged parallel to mounting plate 210 of the gantry support.

At least one journal bearing 301 is fixedly attached to support plate 303 of carriage apparatus 302. In one embodiment, two spaced apart bearings 301 are provided to create two points for supporting carriage apparatus 302 from the gantry support 202. The support rod 214 of the gantry support 202 is concentrically aligned with and passes through through-holes defined by the journal bearings 301. The support plate 303 and journal bearing 301 assembly is slidable along the support rod 214 as a single unit for laterally positioning the cutting tool unit and blade 310 with respect to the material support 400 (and workpiece W when positioned thereon).

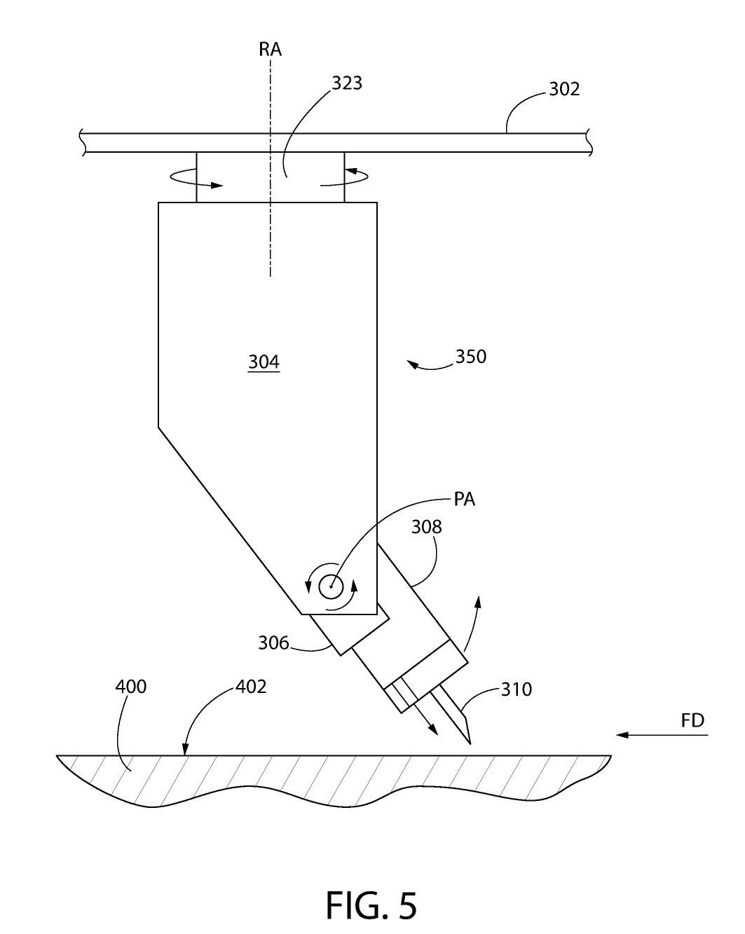

Referring to FIGS. 1-9, tool support apparatus 304 in one embodiment may comprised a generally inverted U-shaped member formed of two spaced apart vertical plates 322 and a horizontal top plate 321 adjoined therebetween. This creates a cavity 320 which opens downwardly and at least axially on one side of the tool support apparatus to permit the cutting blade 310 to engage and be angled with respect to the workpiece W. In one embodiment, the tool support apparatus 304 may be rotationally supported by the carriage apparatus 302 via a rotational bearing 323. This defines a rotational axis RA (see, e.g. FIG. 5) and permits the orientation of the cutting blade 310 to be oriented with respect to the feed direction FD of the workpiece and the material support 400. Accordingly, cut marks may be thus be made perpendicular to, parallel to, and oblique to the feed direction in various arrangements.

Tool carrier apparatus 306 comprises a U-shaped cradle configured for holding the reciprocating tool apparatus 308. Apparatus 306 includes a rear wall 330 and adjoining pair of spaced apart sidewalls 332 forming a forwardly open receptacle that supports and receives reciprocating tool apparatus 308 mounted at least partially therein. Tool carrier apparatus 306 may be pivotably mounted to tool support apparatus 304 about a pivot 334 which defines a pivot axis PA (see, e.g. FIG. 5). This allows the tool carrier apparatus 306 to be angled or tilted with respect to tool support apparatus 304, which in turn allows the cutting blade carried by tool apparatus 308 to be angled or tilted with respect to material support 400 (and workpiece W when positioned thereon). Accordingly, the distressing apparatus is mounted adjacent the material support so that the impact axis IA (see, e.g. FIG. 6A) is obliquely oriented relative to the material support plane (top surface 402) and intersects the material support plane at an intersection point so as to form an acute tilt angle A1 with a portion of the material support plane that is downstream of the intersection point and an obtuse tilt angle A2 with a portion of the material support plane that is upstream of the intersection point, wherein downstream and upstream are defined with respect to the material feed direction FD. In some embodiments, angle A1 may be between 0 and 90 degrees, alternatively between 0 and 60 degrees, and alternatively between 0 and 45 degrees. In some embodiments, angle A2 may be between 90 and 180 degrees, alternatively between 90 and 140 degrees, and alternatively between 90 and 120 degrees.

Reciprocating tool apparatus 308 includes an outer housing 309 and cutting blade 310 which is movable between at least partially retracted or projected positions with respect to the housing. The tool apparatus 308 is vertically movable in position and height with respect to the tool carrier apparatus 306 which supports the tool apparatus, and the material support 400 (and workpiece W when positioned thereon). In one embodiment, tool apparatus 308 may include an electrically or pneumatically actuated piston to which the cutting blade 310 is attached. In one non-limiting embodiment, the piston is pneumatically actuated as disclosed herein. The housing 309 may be configured to define the piston cylinder or bore in which the piston is slideably movable back and forth in a reciprocating manner Cutting blade 310 may be attached to a terminal bottom end of the piston and concomitantly is movable in a rapid reciprocating motion between the retracted and projected positions for cutting and distressing the workpiece W.

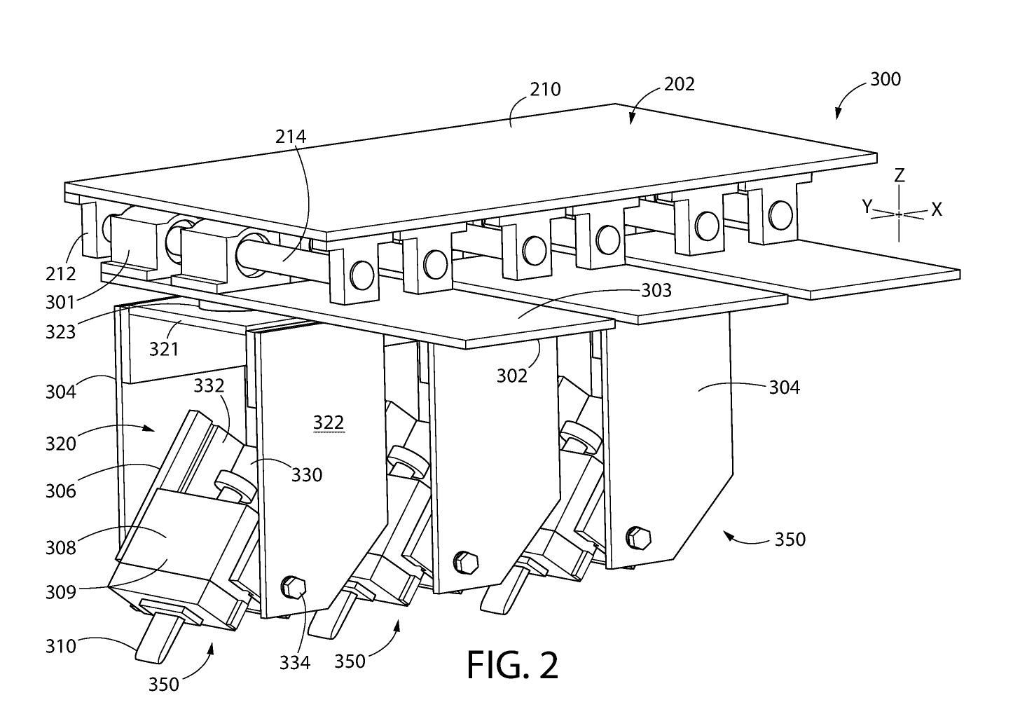

Each cutting tool unit 350 of the distressing apparatus 300 may be articulated and moved in multiple degrees of freedom or motion with respect to an X-Y-Z axis Cartesian coordinate system shown for reference in FIG. 2. The feed direction FD defines the X-axis. The across-feed direction AFD defines the Y axis. And the vertical direction defined perpendicular to the top surface 402 of the material support 400 defines the Z axis.

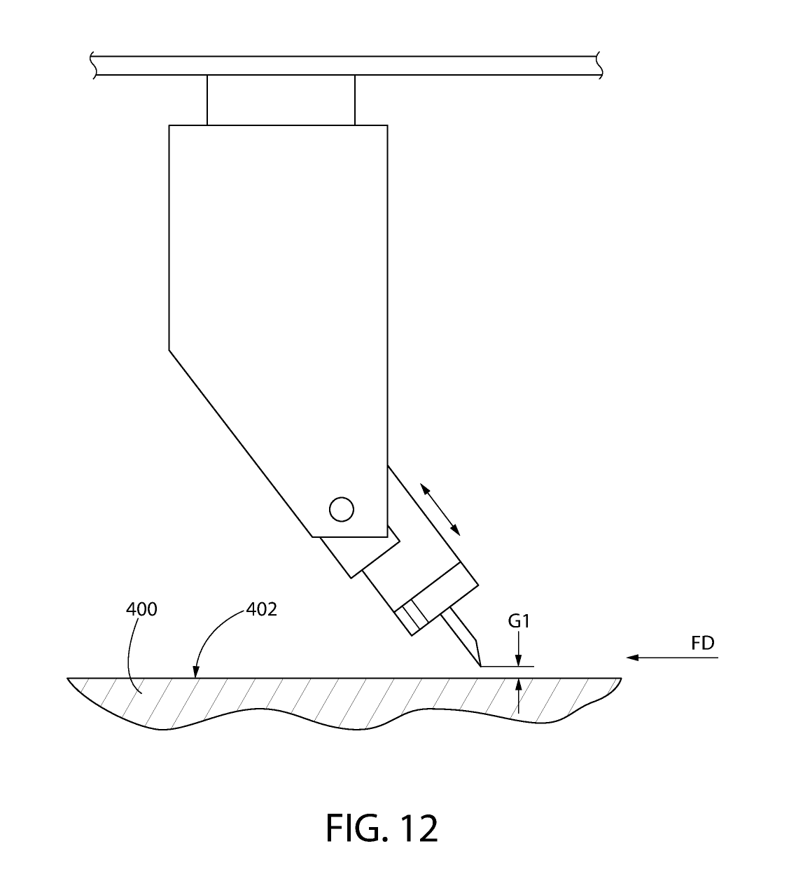

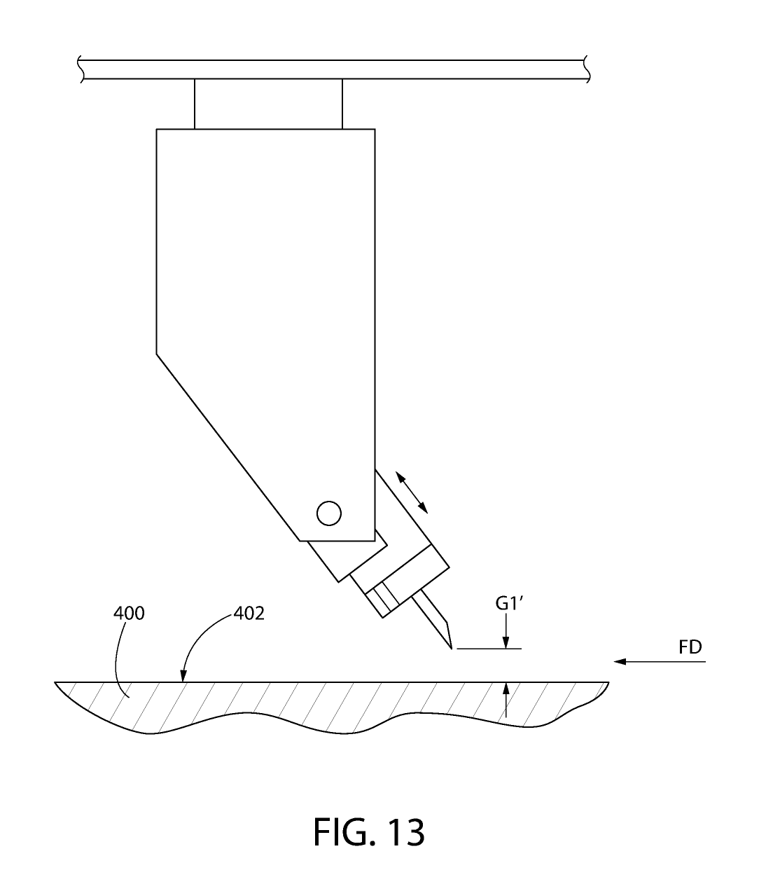

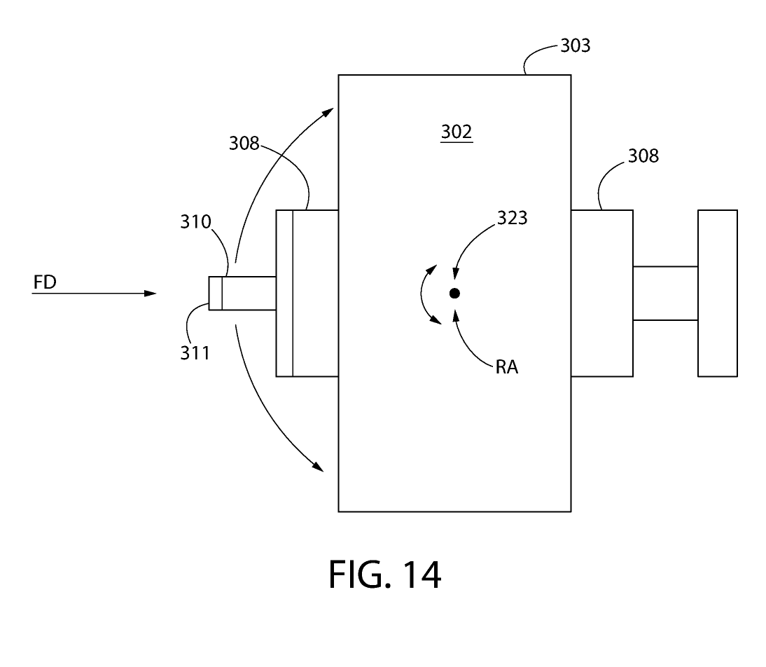

Referring to FIG. 5, each cutting tool unit 350 is rotatable about the Z axis via the rotational bearing 323. This allows the angular position of the cutting blade 310 with respect to the feed direction FD and X-axis to be adjusted. FIG. 14 shows tool support apparatus 304 with supported cutting blade 310 oriented substantially parallel to feed direction FD and the X-axis. FIG. 15 shows tool support apparatus 304 with supported cutting blade 310 oriented obliquely at an angle A3 to the feed direction FD and the X-axis. Tool carrier apparatus 306 is also visible in this figure and obliquely oriented as well because the tool carrier apparatus rotated in unison with the tool support apparatus 304. FIG. 16 shows tool support apparatus 304 with supported cutting blade 310 oriented obliquely at a different angle A4 to the feed direction FD and the X-axis.

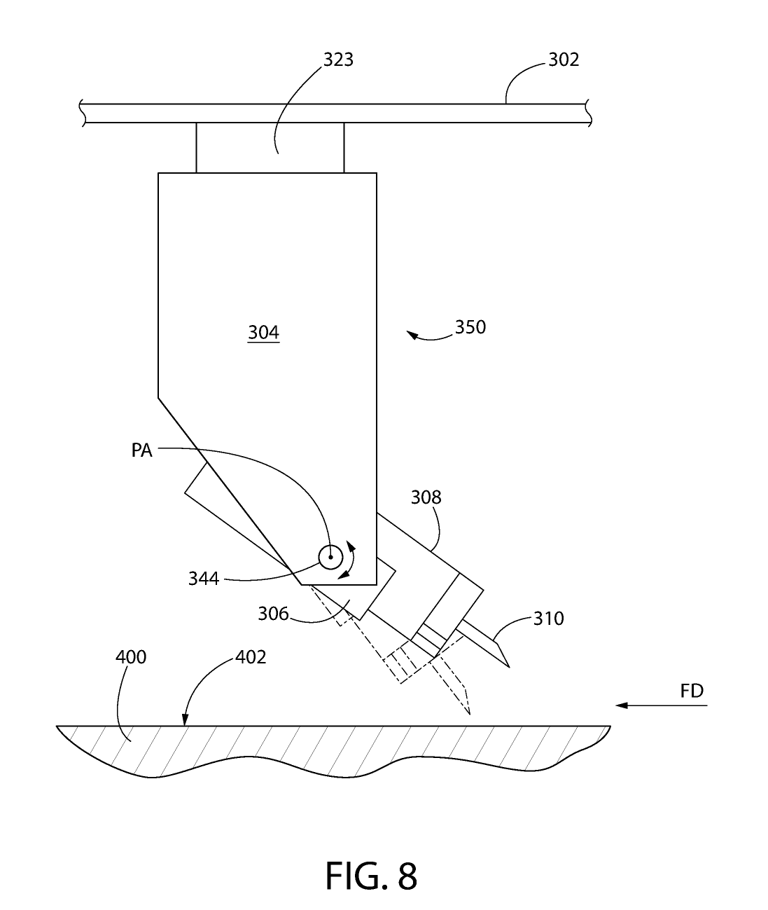

The cutting tool units 350 are further laterally movable along the Y-axis parallel to the across-feed direction AFD. This adjusts the lateral position of the blade 310 with respect to material support 400 (and workpiece W when positioned thereon). Each cutting tool unit 350 and blades 310 may be arranged in the same or different lateral positions with respect to the material support 400 (and workpiece W when positioned thereon). In FIG. 10, the cutting blade 310 of each cutting tool unit 350 is coaxially aligned along its impact axis IA with the other blades in a first lateral position P1. This may be used to form a series of three separate groupings of longitudinally spaced chatter marks or cuts axially aligned along feed direction FD in one distressing process. In other distressing processes, a single group of chatter marks or cuts C may be formed by repeated striking the same general region of workpiece W with each of the cutting tools 350 wherein the grouping of marks represented strikes received from all three cutting tool blades 310.

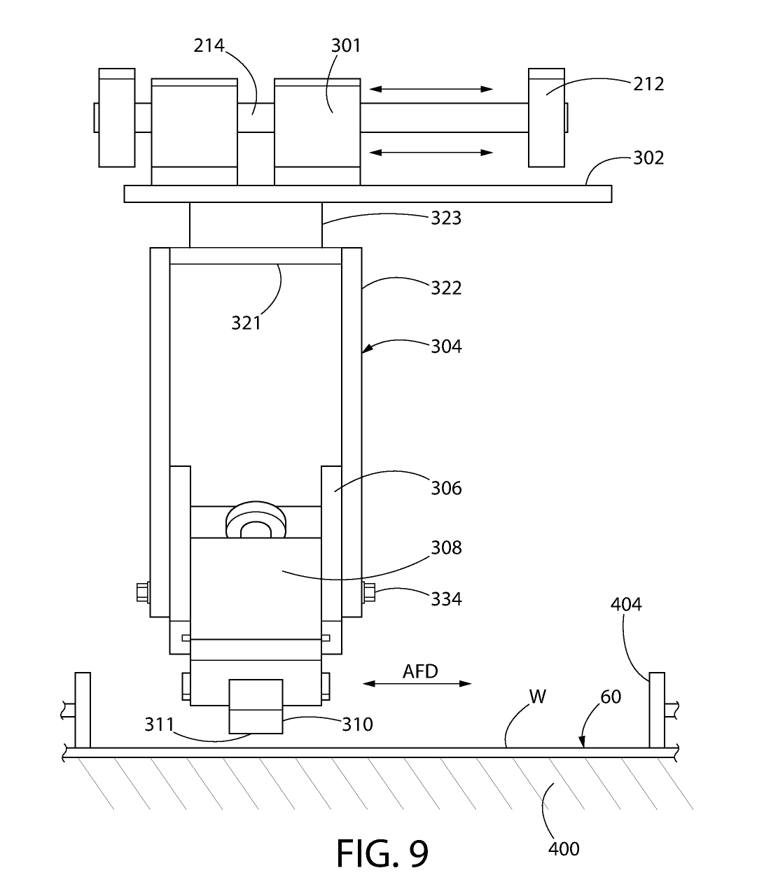

Conversely, in FIG. 11, the cutting blades 310 of the three cutting tool units 350 shown are arranged in different first, second, and third lateral positions P1, P2, P3 respectively so that none of the impact axes IA are coaxially aligned. This will produce a a series of three separate groupings of distress marks or cuts C at three different lateral positions in the top surface 60 of the workpiece W rather than along the same feed direction axial line using the arrangement in FIG. 10. Numerous positional variations of the cutting blades 310 are possible to form different visual effects and groupings of chatter marks.

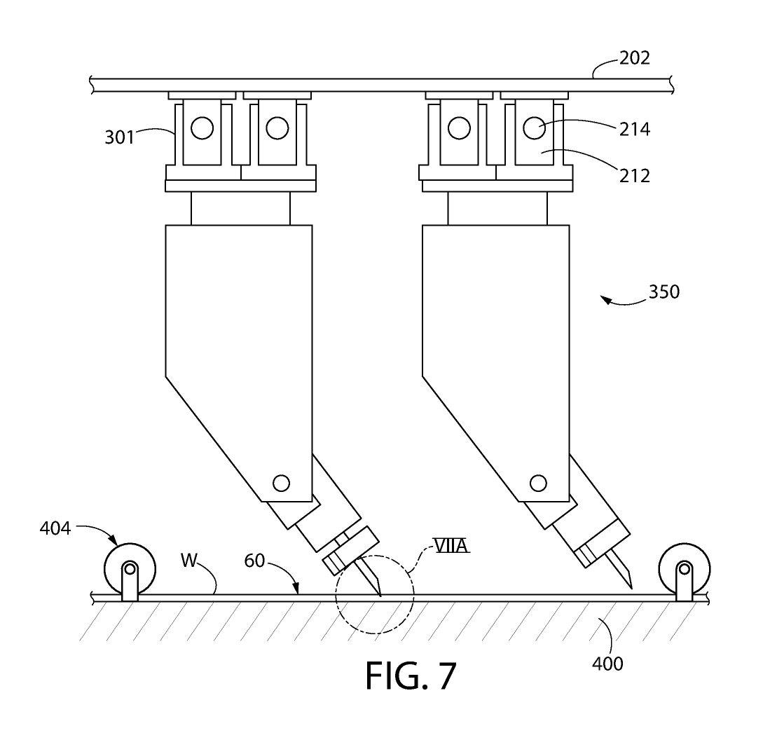

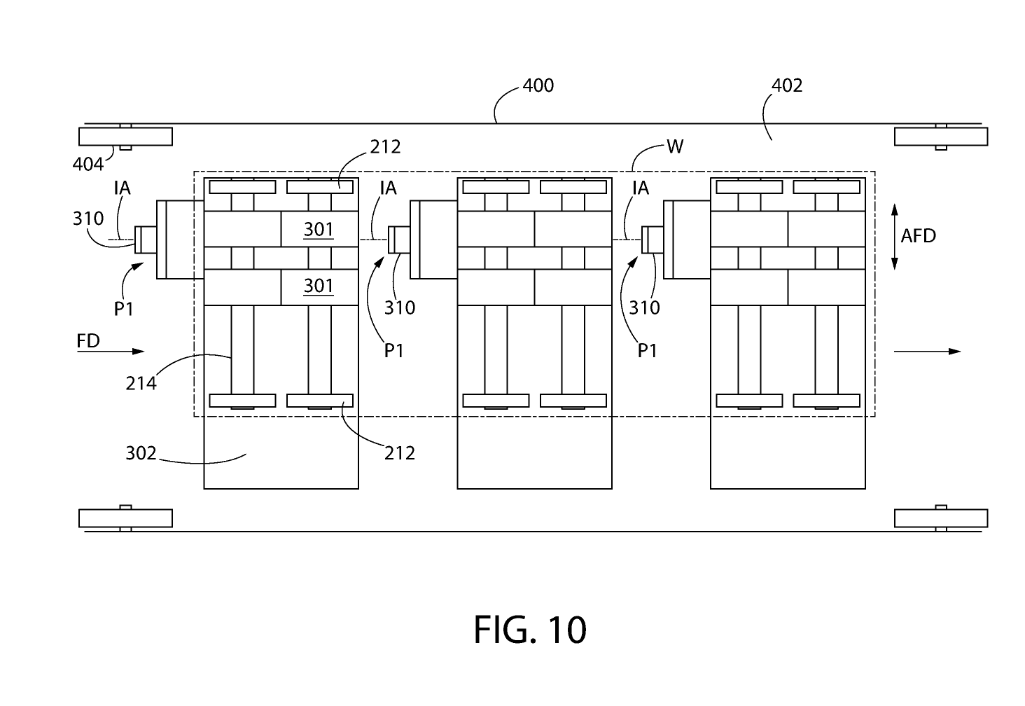

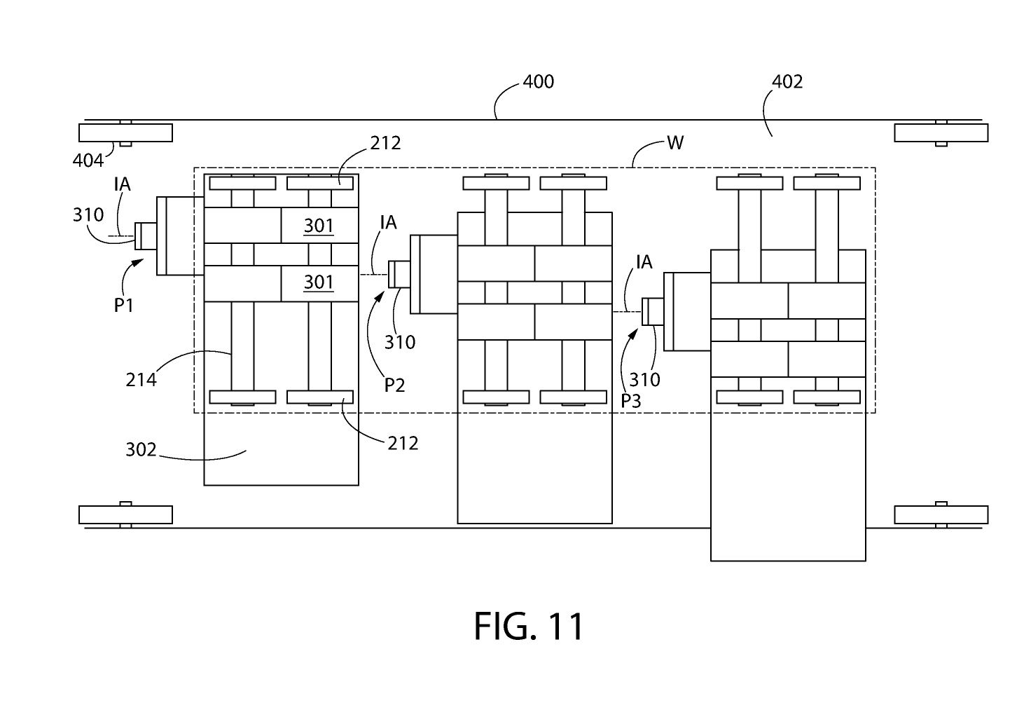

Referring to FIGS. 5 and 6A, the tiltable reciprocating tool apparatus 308 and cutting blade 310 are adjustable in tilt angle A1 with respect to the X-Y plane that coincides with the planar top surface 402 of the material support 400. FIG. 8 shows two different positions of the tool apparatus and blade. The reciprocating tool apparatus 308 and cutting blade 310 are further adjustable in height with respect to the X-Y plane that coincides with the planar top surface 402 of the material support 400. This allows adjustment of the gap G1 formed between the tip 311 of blade 310 and top surface 402 of material support 400 to be adjusted. FIGS. 12 and 13 show two different height positions of the tool apparatus and blade (gap G1′ being larger than G1, respectively). Concomitantly, this further adjusts the gap G2 between the top surface 60 of workpiece W and tip 311 of blade 310 to be adjusted to accommodate different thicknesses T1 of workpieces because the position of material support top surface 402 may be fixed in some embodiments. In other embodiments, the material support 400 may be vertically adjustable in height to alter the position of top surface 402.

In some operations, it may be desirable to always maintain the same gap G1 or G2 regardless of the tilt angle A1 of the blade 310 to match the firing stroke of the piston which typically remains relatively constant. This ensures that the depth of cut into the workpiece may be controlled and maintained. The combination of dual tilt and height adjustment of the blade provides for such positioning.

In one embodiment, a control system including a controller 100 may be operably coupled to the distressing apparatus 300 and to the drive subsystem 106 as referenced in FIG. 1 to control the firing operation of the piston-blade assembly, feed rate of workpiece W through the distressing apparatus 300, and positional adjustment of the cutting tool units 350 as described above. The controller 100 may include one or more electronic data processors, circuitry, and ancillary electronic components configured to control a combination of electric (linear actuators) and/or pneumatic actuators for positional adjustment as well as control operation of electric motor drives that power the drive rollers 404 for translating the workpiece W relative to the material support 400.

The control system 100 may include a rotational actuator 108, AFD actuator 110, angular actuator 112, and height actuator 114 whose operation is controlled by controller 102 via wired and/or wireless communication links. Rotational actuator 108 is configured to control the rotational position of tool support apparatus 304 and cutting blade 310 relative to the Z-axis and material support 400 (and workpiece W when positioned thereon). AFD (across-feed direction) actuator 110 is configured to control the lateral positions of the cutting tool units 350 and cutting blades 310 relative to the material support 400 (and workpiece W when positioned thereon). Angular actuator 112 is configured to control the tilt or angular position of the reciprocating tool apparatus 308 and cutting blade 310 relative to material support 400 (and workpiece W when positioned thereon). Height actuator 114 is configured to control the height of reciprocating tool apparatus 308 and cutting blade 310 relative to material support 400 (and workpiece W when positioned thereon).

Controller 102 controls the workpiece W feed rate or speed through the distressing apparatus 300 via controlling the rotational speed of the drive rollers 404.

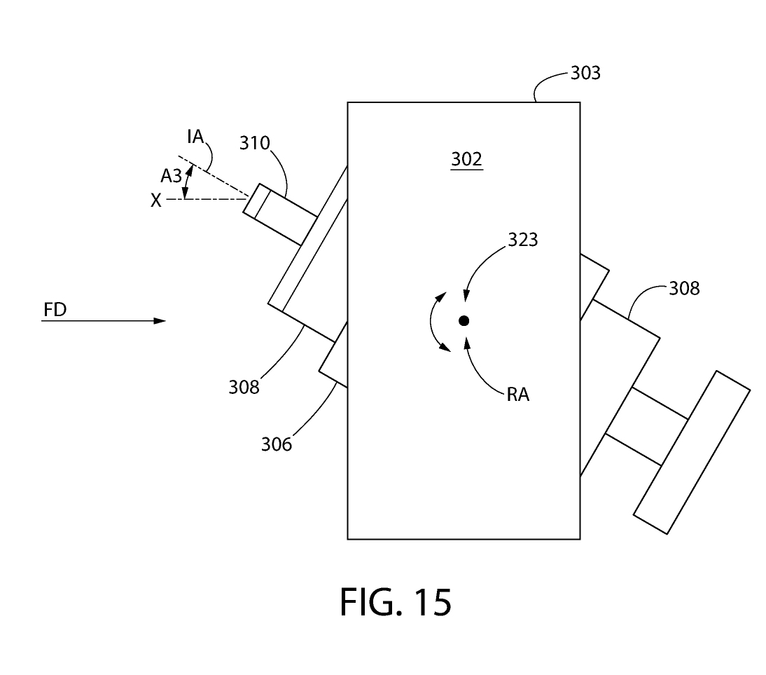

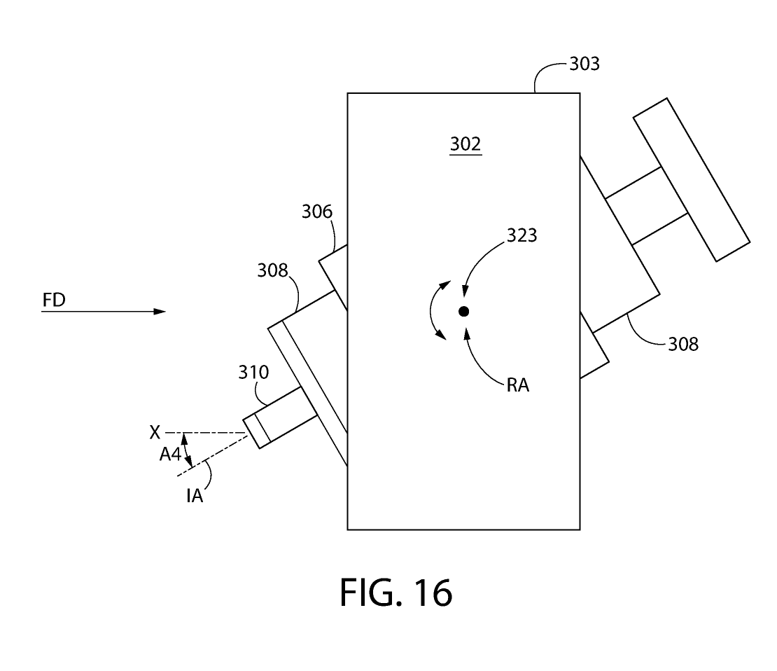

If the cutting tool units 350 are pneumatically controlled, controller 102 may control operation of an air supply/exhaust subsystem 104 which operates the positional actuators for adjusting the position of the cutting blades 310 and firing rate of the cutting tool pistons. FIGS. 17 and 18 show a cross section of a reciprocating tool apparatus 308 and piston assembly 400. Piston assembly 400 includes a cylinder or bore 402 and piston 408 slideably disposed in the bore. Piston 408 is connected to a piston shaft 404 having an internal portion disposed in the bore 402 and an external portion which penetrates an end wall of the tool outer housing 309. A blade assembly comprising blade 310 and coupling 310a is mounted on the external terminal end of the shaft 404 as shown. A pressurized air supply 410 is provided which is fluidly connected to two three-way valves 412 which in turn are fluidly connected to bore 402 on opposing sides of piston 408. An annular seal 406 is attached to piston 408 which moves with the piston to fluidly isolate two regions of the bore 402 for operating the piston assembly 400.

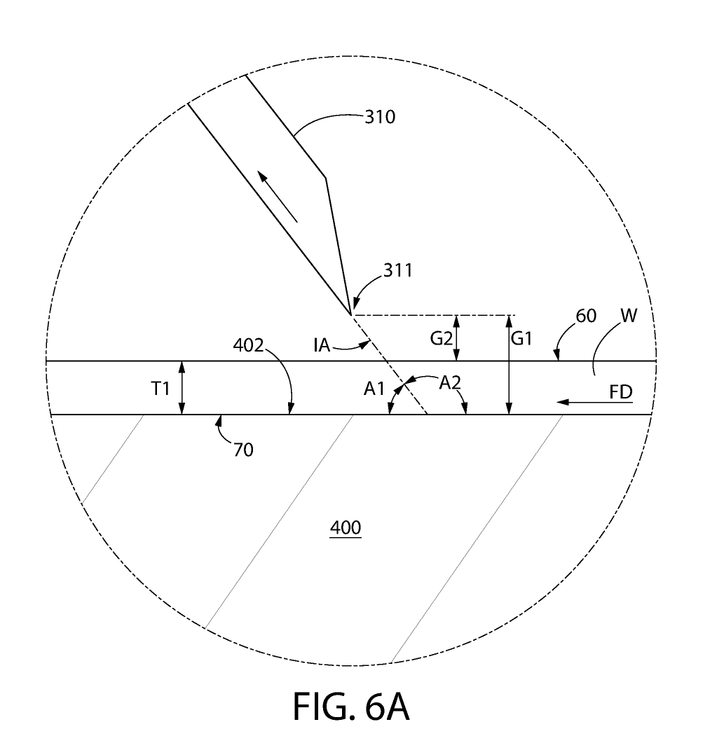

In operation during the forward power stroke shown in FIG. 17, controller 102 controls the position of the first valve 412 to supply pressurized air to the region of bore 402 above the piston 408. This drives the piston and shaft 404 with blade 410 attached thereto downward towards the material support 400 and workpiece W when positioned thereon. Controller 102 controls the position of the second valve 412 fluidly coupled to region of bore 402 below the piston so that air is extracted from the bore and exhausted to atmosphere. The power stroke is sufficient in length to engage cutting blade 310 with workpiece W and cut the material as shown in FIG. 7A.

During the rearward retraction stroke shown in FIG. 18, the controller 102 regulates the air supply through valves 412 in an opposite manner to that described above and shown in FIG. 17. The cutting blade 410 is retracted and disengaged from workpiece W as shown in FIG. 6A. The piston 404 and cutting blade reciprocate in a rapid linear motion between the power and retraction strokes to cut grooves or indentations into the workpiece W. In some embodiments, several successive cycles of power and retraction strokes (i.e. every power and retraction combination defining one cycle) may occur each second or minute. Blade 310 rapidly strikes the surface of workpiece W to create a series or grouping of closely spaced indented “chatter marks” separated by a short distance. Such chatter marks are distinguishable from machine or manually made distress marks comprised of a single long scrape mark or cut which provides a different visual effect. The timing between the stroke cycles affects the linear spacing of distressing cuts formed in the top surface 60 of the workpiece W. In some embodiments, each reciprocating tool apparatus 308 may comprise two piston assemblies 400 which are connected to a single blade 310 to increase the impact and cutting force.

In various representative but non-limiting embodiments, each cutting blade 310 may reciprocate at a stroke rate between about and including 100-10,000 cycles/minute, alternatively about and including 1,000-5,000 cycles/minute, and alternatively 1,300-3,000 cycles/minute.

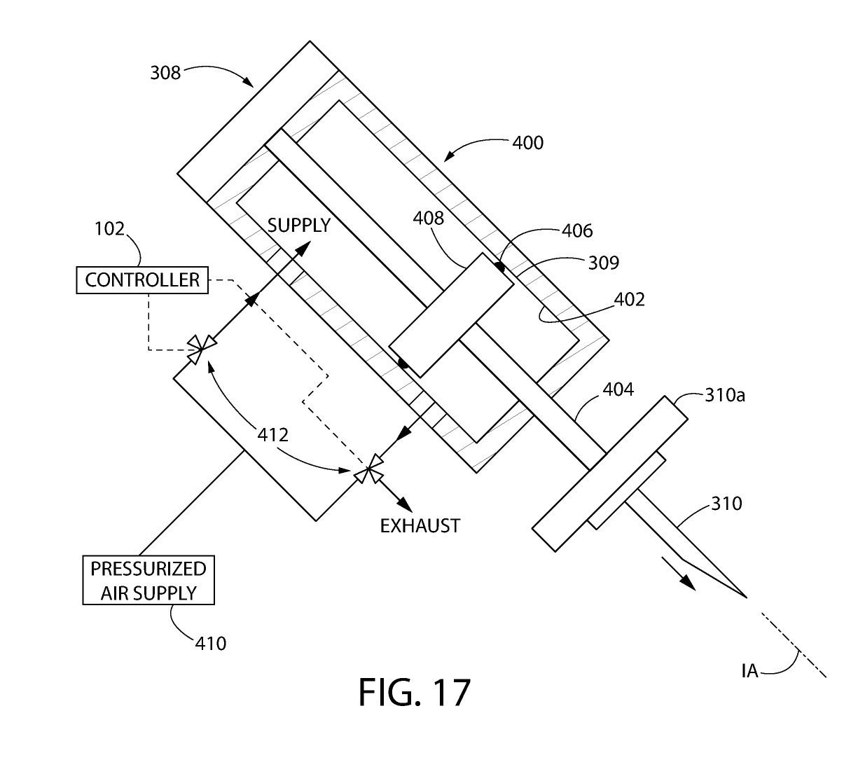

Referring to FIG. 19, it will be appreciated the speed of the workpiece W affects the linear length L of the distressing groove or cut C formed by increasing or decreasing the contact time of the blade 410 with the workpiece. At a constant firing rate of the piston and blade, the faster the workpiece W feed rate or speed, the longer the contact time of the blade 410 with the workpiece to form a longer cut C, and vice versa. In a similar manner, increasing or decreasing the firing rate of the piston and blade at a constant workpiece feed rate will change the length L of the cut C. In some embodiments, the length L of groove or cut C may be between about and including 0.125 to 6 inches, alternatively between 0.25 and 4 inches. Other lengths L of cuts may be used.

The depth D of the grooves or cuts C may be changed by increasing or decreasing the length of the piston-blade power stroke or changing the gap between the workpiece and blade to make shallower or deeper cuts. Blade 310 in one embodiment is configured to form a cut C in workpiece W as shown in FIG. 19. Each of the plurality of substantially parallel seriatim grooves or cuts C comprises a first angled side wall 314 extending from the major to surface 60 of the workpiece W and a second angled side wall 315 extending from the first angled sidewall to the major surface 60. The angled side walls of each groove or cut C comprises two acute angles including a downstream angle A5 (with respect to the feed direction FD) formed by side wall 314 and an upstream angle A6 (with respect to feed direction FD) formed by side wall 315. The first acute angle A5 is formed between the first angled sidewall and a horizontal reference line R1 oriented generally parallel to top surface 60 of workpiece W. which is defined by the depth of cut D and includes A point of intersection of the first and second angled sidewalls 314, 315 that defines the depth of cut D and location of reference line R1.

Angle A5 is less than angle A6 in certain embodiments as shown. Angles A5 and A6 may be between 0 and 90 degrees. In certain embodiments, angle A5 may be between 0 and 30 degrees, alternatively between 0 and 20 degrees. Angle A6 may be between 0 and 60 degrees, alternatively between 0 and 45 degrees in certain embodiments. It will be appreciated that the angles A5 and A6 may be altered by changing the tilt of the reciprocating tool apparatus 308 with respect to the material support 400, as describe herein.

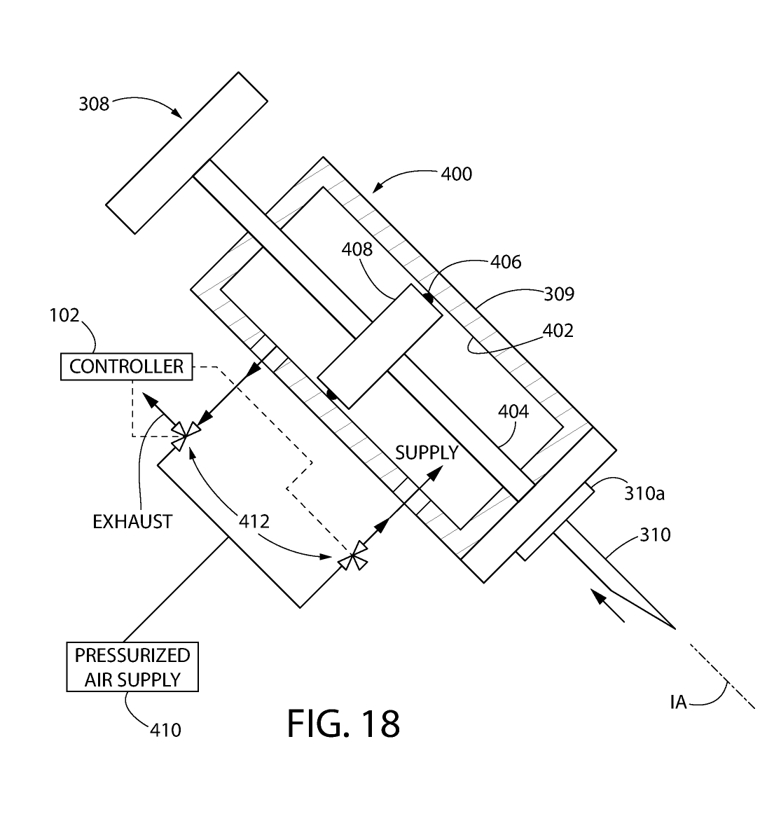

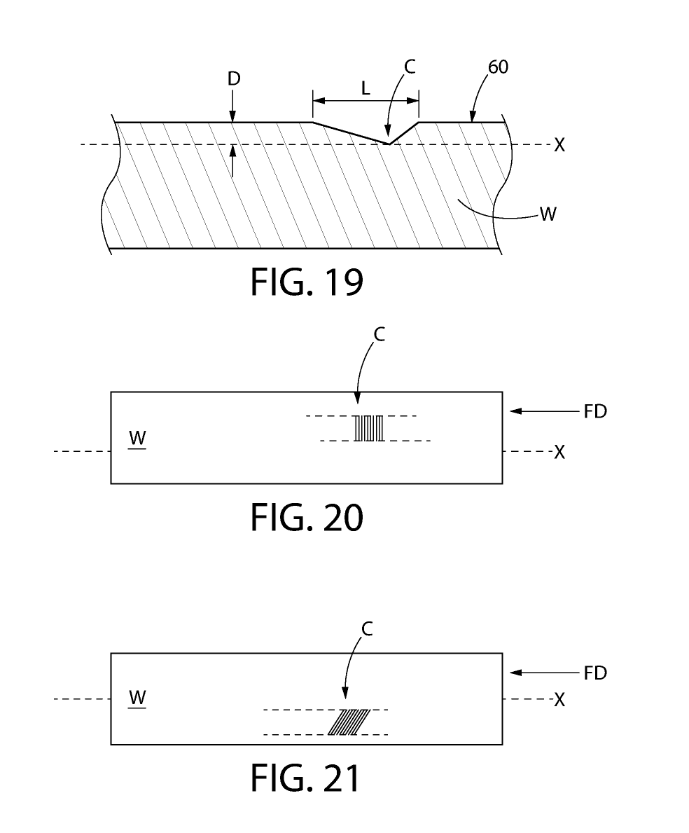

FIG. 20 shows a series of relatively closely spaced chatter marks or cuts C which may be formed by rapid firing of the pistol-blade assembly. The distress cuts C shown in this figure are made with the broadened cutting blade 310 oriented laterally and perpendicular to the feed direction FD. In FIG. 21, the distress cuts C are made with the cutting blade 310 oriented obliquely to the feed direction FD. The chatter marks are each formed of a substantially parallel seriatim grooves or cuts C.

In one mode of operation, the pistons 404 and blades 310 in each cutting unit of a distressing apparatus 300 are preferably not fired at the same time. The inventors have discovered that simultaneous firing may impede the feed of the workpiece and adversely affect the appearance and quality of distress cuts C formed.

As may be used throughout this disclosure, ranges if cited are used as shorthand for describing each and every value that is within the range. Any value within the range can be selected as the terminus of the range. In addition, all references cited herein are hereby incorporated by referenced in their entireties. In the event of a conflict in a definition in the present disclosure and that of a cited reference, the present disclosure controls.

Various exemplary embodiments of the present invention may include one or more of the configurations or operating methods described in the exemplary claims, which form part of the disclosure and specification.

While the foregoing description and drawings represent exemplary embodiments of the present disclosure, it will be understood that various additions, modifications and substitutions may be made therein without departing from the spirit and scope and range of equivalents of the accompanying claims. In particular, it will be clear to those skilled in the art that the present invention may be embodied in other forms, structures, arrangements, proportions, sizes, and with other elements, materials, and components, without departing from the spirit or essential characteristics thereof. In addition, numerous variations in the methods/processes described herein may be made within the scope of the present disclosure. One skilled in the art will further appreciate that the embodiments may be used with many modifications of structure, arrangement, proportions, sizes, materials, and components and otherwise, used in the practice of the disclosure, which are particularly adapted to specific environments and operative requirements without departing from the principles described herein. The presently disclosed embodiments are therefore to be considered in all respects as illustrative and not restrictive. The appended claims should be construed broadly, to include other variants and embodiments of the disclosure, which may be made by those skilled in the art without departing from the scope and range of equivalents.

What is claimed is:

1. A system for distressing a major surface of a plank comprising:
a material support defining a material support plane for supporting the plank;
a distressing apparatus mounted adjacent the material support, the distressing apparatus comprising a blade terminating in a blade edge, the distressing apparatus configured to translate the blade back-and-forth along an impact axis between: (1) an extended state in which the blade edge is a first distance from the material support plane; and (2) a retracted state in which the blade edge is a second distance from the material support plane, the second distance being greater than the first distance;
a drive subsystem configured to generate relative movement between the plank and the distressing apparatus so that the plank translates relative to the distressing apparatus so as to define a material feed direction;
the distressing apparatus mounted adjacent the material support so that the impact axis is obliquely oriented relative to the material support plane and intersects the material support plane at an intersection point so as to form an acute angle with a portion of the material support plane that is downstream of the intersection point and an obtuse angle with a portion of the material support plane that is upstream of the intersection point, wherein downstream and upstream are defined with respect to the material feed direction; and
a controller operably coupled to the distressing apparatus and to the drive subsystem, the controller configured to repetitively fire the blade back-and forth between the extended state and the retracted state for a period of time so that the blade edge repetitively impacts the major surface of the plank when in the extended state as the plank is translated in the material feed direction by the drive subsystem, thereby forming a chatter mark in the major surface of the plank.

2. The system according to claim 1 further comprising:
the distressing apparatus configured so that the blade edge is translatable relative to the material support in an across-feed direction;
an across-feed direction actuator operably coupled to the distressing apparatus to translate the blade edge in the across-feed direction; and
the controller operably coupled to the across-feed direction actuator and configured to position the blade edge in a selected one of a plurality of across-feed direction positions.

3. The system according to claim 1 further comprising:
the distressing apparatus configured so that the blade edge is rotatable relative to the material support about a first rotational axis that is substantially perpendicular to the material support plane;
a rotational actuator operably coupled to the distressing apparatus to rotate the blade edge about the first rotational axis; and
the controller operably coupled to the rotational actuator and configured to rotate the blade edge about the first rotational axis to a selected one of a plurality of angular orientations.

4. The system according to claim 1 further comprising:
the distressing apparatus configured so that a value of the acute angle formed between the impact axis and the portion of the material support plane that is downstream of the intersection point is adjustable;
an angular actuator operably coupled to the distressing apparatus to change the value of the acute angle that is formed between the impact axis and the portion of the material support plane that is downstream of the intersection point; and
the controller operably coupled to the angular actuator and configured to adjust the value of the acute angle that is formed between the impact axis and the portion of the material support plane that is downstream of the intersection point to a selected one of a plurality of acute angle values.

5. The system according to claim 1 further comprising:
the distressing apparatus configured so that a value of the second distance is adjustable;
a height actuator operably coupled to the distressing apparatus to adjust the value of the second distance; and
the controller operably coupled to the height actuator and configured to position the blade edge so that the second distance is at a selected one of a plurality of height values.

6. The system according to claim 1 further comprising:
a fixed support assembly; and
the distressing apparatus comprising: a carriage apparatus mounted to the fixed support assembly; a tool support apparatus mounted to the carriage apparatus; a tool carrier apparatus mounted to the tool support apparatus, and a reciprocating tool apparatus mounted to the tool carrier apparatus, the reciprocating tool apparatus comprising the blade.

7. The system according to claim 6 wherein the carriage apparatus is mounted to the fixed support assembly so as to be capable of translating relative to the material support in an across-feed direction so that the blade edge can be positioned in a selected one of a plurality of across-feed direction positions.

8. The system according to claim 7 further comprising an across-feed direction actuator operably coupled to the carriage apparatus to translate the blade edge in the across-feed direction.

9. The system according to claim 6 wherein the tool support apparatus is rotatably mounted to the carriage apparatus so as to be capable of rotating relative to the material support about a first rotational axis that is substantially perpendicular to the material support plane so that the blade edge can be oriented in a selected one of a plurality of angular orientations about the first rotational axis.

10. The system according to claim 9 further comprising a rotational actuator operably coupled to the tool support apparatus to rotate the blade edge about the first rotational axis.

11. The system according to claim 6 wherein the tool carrier apparatus is mounted to the carriage apparatus so as to be capable of adjusting a value of the acute angle formed between the impact axis and the portion of the material support plane that is downstream of the intersection point.

12. The system according to claim 11 further comprising an angular actuator operably coupled to the tool carrier apparatus to change the value of the acute angle that is formed between the impact axis and the portion of the material support plane that is downstream of the intersection point

13. The system according to claim 6 wherein the reciprocating tool apparatus is mounted to the tool carrier apparatus so as to be capable of adjusting a value of the second distance.

14. The system according to claim 13 further comprising a height actuator operably coupled to the reciprocating tool apparatus to change the second distance to a selected one of a plurality of height values.

15. The system according to claim 1 wherein the distressing apparatus comprises a double-acting pneumatic cylinder, the blade mounted to a piston apparatus of the double-acting pneumatic cylinder.

16. The system according to claim 15 wherein the distressing apparatus further comprises an air supply and exhaust subsystem operably coupled to the double-acting pneumatic cylinder, the controller operably coupled to the air supply and exhaust subsystem to repetitively fire the blade back-and forth between the extended state and the retracted state for a predetermined period of time and at a predetermined stroke rate.

17. The system according to claim 16 wherein the predetermined period of time is selected to create the chatter mark in the major surface of the plank so that the chatter mark has a predetermined length.

18. The system according to claim 16 wherein the air supply and exhaust subsystem comprises: a first proportional valve operably coupled to a first air supply line fluidly coupled to an extension stroke chamber of the double-acting pneumatic cylinder, the first proportional valve operably coupled to the controller; and a second proportional valve operably coupled to a second air supply line fluidly coupled to a retraction stroke chamber of the double-acting pneumatic cylinder, the second proportional valve operably coupled to the controller.

19. The system according to claim 1 further comprising a gantry-style support assembly that straddles the material support, the distressing apparatus mounted to the gantry-style support assembly.

20. A system for distressing a major surface of a plank comprising:
a material support defining a material support plane for supporting the plank;
a plurality of distressing apparatuses, each of the plurality of distressing apparatuses mounted adjacent the material support, each of the plurality of distressing apparatuses comprising a blade terminating in a blade edge and being configured to translate the blade back-and-forth along an impact axis between: (1) an extended state in which the blade edge is a first distance from the material support plane; and (2) a retracted state in which the blade edge is a second distance from the material support plane, the second distance being greater than the first distance;
a drive subsystem configured to generate relative movement between the plank and the plurality of distressing apparatuses so that the plank translates relative to the plurality of distressing apparatuses so as to define a material feed direction;
the plurality of distressing apparatuses mounted adjacent the material support in a spaced-apart manner in the material feed direction; and
a controller operably coupled to each of the plurality of distressing apparatuses and to the drive subsystem, and, for each of the plurality of distressing apparatuses, the controller configured to repetitively fire the blade back-and forth between the extended state and the retracted state so that the blade edge repetitively impacts the major surface of the plank when in the extended state as the plank is translated in the material feed direction by the drive subsystem, thereby forming a chatter mark in the major surface of the plank.

21. The system according to claim 20 wherein each of the plurality of distressing apparatuses is mounted adjacent the material support so that the impact axis is obliquely oriented relative to the material support plane and intersects the material support plane at an intersection point so as to form an acute angle with a portion of the material support plane that is downstream of the intersection point and an obtuse angle with a portion of the material support plane that is upstream of the intersection point, wherein downstream and upstream are defined with respect to the material feed direction.

22. The system according to claim 20 wherein the blade edges of adjacent ones of the plurality of distressing apparatuses are separated from one another by at least a first distance in the material feed direction; wherein, for each of the plurality of distressing apparatuses, the controller is configured to repetitively fire the blade back-and forth between the extended state and the retracted state for a predetermined period of time that is selected to create the chatter mark in the major surface of the plank so that the chatter mark has a predetermined length in the material feed direction; and wherein the predetermined length is less than the first distance.

23. The system according to claim 20 wherein the plurality of distressing apparatuses are aligned with one another in the material feed direction; and the controller configured to: (a) repetitively fire the blade of a first one of the plurality of distressing apparatuses back-and forth between the extended state and the retracted state to create a first one of the chatter mark in the major surface of the plank, and (b) repetitively fire the blade of a second one of the plurality of distressing apparatuses back-and forth between the extended state and the retracted state to create a second one of the chatter mark in the major surface of the plank that at least partially overlies the first one of the chatter mark.

24. The system according to claim 20 wherein the plurality of distressing apparatuses are offset from one another in the material feed direction so as to create chatter marks in the major surface of the plank at different across-feed positions.

25. A method of distressing a major surface of a plank, the method comprising:
a) supporting the plank on a material support;
b) creating relative translational movement between the plank and a distressing apparatus mounted adjacent the material support using a drive subsystem, the distressing apparatus comprising a blade terminating in a blade edge, the plank translating relative to the distressing apparatus so as to define a material feed direction; and
c) repetitively firing the blade back-and-forth along an impact axis between (1) an extended state in which the blade edge is driven into the major surface of the plank, and (2) a retracted state in which the blade edge is a spaced a distance from the major surface of the plank, thereby creating a chatter mark in the major surface of the plank; and
wherein step c) is performed while continuing said relative translational movement of step b).

26. The method according to claim 25 wherein the chatter mark formed in step c) comprises a plurality of substantially parallel seriatim grooves.

27. The method according to claim 26 wherein the plurality of substantially parallel seriatim grooves extend substantially perpendicular to the feed direction.

28. The method according to claim 26 wherein the plurality of substantially parallel seriatim grooves extend obliquely to the feed direction.

29. The method according to claim 26 wherein each of the plurality of substantially parallel seriatim grooves is substantially linear.

30. The method according to claim 26, wherein the distressing apparatus is mounted adjacent the material support so that the impact axis is obliquely oriented relative to a material support plane defined by the material support and intersects the material support plane at an intersection point so as to form an acute angle with a portion of the material support plane that is downstream of the intersection point and an obtuse angle with a portion of the material support plane that is upstream of the intersection point, wherein downstream and upstream are defined with respect to the material feed direction.
